(19) United States
(12) Patent Application Publication
(10) Pub. No.: US 2026/0069109 A1
(43) Pub. Date: Mar. 12, 2026

(54) ACCURATE CHEMICAL DISTRIBUTION DEVICE WITH RESIDUAL DETECTION

(71) Applicant: Ecolab USA Inc., Saint Paul, MN (US)

(72) Inventors: Tong Li, Pudong (CN); John Wu, Pudong (CN)

(21) Appl. No.: 19/132,754

(22) PCT Filed: Feb. 28, 2023
(86) PCT No.: PCT/CN2023/078700

§ 371 Date: May 23, 2025

(51) Int. Cl. A47L 15/44; A47L 15/42; G01G 23/32

(52) U.S. Cl. CPC A47L 15/4436; A47L 15/4293; A47L 15/4418; G01G 23/32; A47L 2401/023; A47L 2501/26

(57) ABSTRACT

A dispensing device for a washing machine, including a first portion configured to hold and dispense a solid detergent and a liquid detergent, and a second portion configured to hold and dispense a solid rinse aid and a liquid rinse aid. At least one of the first portion or the second portion includes at least one weight sensor on a bottom interior surface, the at least one weight sensor configured to monitor an amount of remaining contents of the at least one of the first portion or the second portion.

### TECHNICAL FIELD

This application relates generally to washing machines and more particularly to a method and apparatus for an accurate chemical distribution device with residual detection for use with a washing machine such as a dishwasher.

### BACKGROUND

A dishwasher, also referred to as a warewasher or warewashing machine, is a machine for automatically cleaning articles, such as dishes, trays, laboratory equipment, dinnerware, and kitchenware. A common domestic dishwasher is an undercounter unit intended to be installed under a kitchen counter. Other types of dishwasher include industrial or commercial dishwashers for use in restaurants, hotels, and other commercial establishments with food services.

Common dishwashers may use a variety of types of liquid or solid detergents (or chemicals) along with water for cleaning articles. Some chemicals are not properly used or fully utilized, resulting in an inefficient use of chemicals and thereby increasing costs of dishwasher operation and increasing needed storage space for dishwasher chemicals.

What is needed is an improved dispenser or distribution device for a dishwasher that provides accurate chemical distribution and residual detection, and that may be used with a variety of different types of chemicals or detergents.

### SUMMARY

An accurate chemical dispensing and distribution device with residual detection is provided. In one example, a dispensing device for a washing machine includes a first portion configured to hold and dispense a solid detergent and a liquid detergent, and a second portion configured to hold and dispense a solid rinse aid and a liquid rinse aid. At least one of the first portion or the second portion includes at least one weight sensor on a bottom interior surface, the at least one weight sensor configured to monitor an amount of remaining contents of the at least one of the first portion or the second portion.

In some examples, the device may also include a one-way pressure relief valve configured to prevent contents of the first portion and the second portion from flowing into an attached water supply. The device may also include a door magnetic switch configured to prevent flushing of the first portion and the second portion when a door of the dispensing device is open, in some examples.

This summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

The drawings illustrate generally, by way of example, various embodiments discussed in the present document. The drawings are for illustrative purposes only and may not be to scale.

FIG. 1A illustrates a perspective view of a chemical distribution device for a dishwasher, according to various embodiments of the present subject matter.

FIG. 1B illustrates a back view of the chemical distribution device of FIG. 1A, according to various embodiments of the present subject matter.

FIG. 1C illustrates the chemical distribution device of FIG. 1A, including a round barrel solid detergent and a solid rinse aid, according to various embodiments of the present subject matter.

FIG. 2A illustrates a chemical distribution device for a dishwasher, including a peanut barrel solid detergent and a solid rinse aid, according to various embodiments of the present subject matter.

FIG. 2B illustrates a tray for supporting the peanut barrel solid detergent of FIG. 2A, according to various embodiments of the present subject matter.

FIG. 3A illustrates a chemical distribution device for a dishwasher, including a pressed-solid detergent and a solid rinse aid, according to various embodiments of the present subject matter.

FIG. 3B illustrates a housing for supporting the pressed-solid detergent of FIG. 3A, according to various embodiments of the present subject matter.

FIG. 4 illustrates a chemical distribution device for a dishwasher, including a round barrel solid detergent and a liquid rinse aid, according to various embodiments of the present subject matter.

FIG. 5 illustrates a chemical distribution device for a dishwasher, including a liquid detergent and a solid rinse aid, according to various embodiments of the present subject matter.

FIG. 6 illustrates an internal portion of a chemical distribution device for a dishwasher, including a one-way pressure relief valve and a solenoid valve, according to various embodiments of the present subject matter.

FIG. 7 illustrates an internal portion of a chemical distribution device for a dishwasher, including a pump module and a solenoid valve, according to various embodiments of the present subject matter.

FIG. 8A illustrates an internal portion of a chemical distribution device for a dishwasher, including a weight sensor, according to various embodiments of the present subject matter.

FIG. 8B illustrates an internal portion of a chemical distribution device for a dishwasher, including a plurality of weight sensors, according to various embodiments of the present subject matter.

FIG. 9A illustrates a table including test results for sensing detergent in a round barrel in a chemical distribution device for a dishwasher, according to various embodiments of the present subject matter.

FIG. 9B illustrates a table including test results for sensing detergent in a peanut barrel in a chemical distribution device for a dishwasher, according to various embodiments of the present subject matter.

FIG. 9C illustrates a table including test results for sensing pressed-solid detergent in a chemical distribution device for a dishwasher, according to various embodiments of the present subject matter.

FIG. 10 illustrates a table including test results for sensing solid rinse aids in a chemical distribution device for a dishwasher, according to various embodiments of the present subject matter.

FIGS. 11A, 11B, 11C, and 11D are illustrations of an embodiment of a dishwasher, with FIG. 11A showing a front view, FIG. 11B showing a side view with a hood of the dishwasher closed, FIG. 11C showing a side view with the hood open, and FIG. 11D showing a top view

FIG. 12 is an illustration of an embodiment of the dishwasher of FIG. 11A with examples of accessories.

FIG. 13 is an illustration of an embodiment of a hydraulic system of the dishwasher of FIG. 11A.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

There is currently a chain trend of catering and restaurant enterprises, and all catering enterprises put forward higher requirements for the miniaturization of storage, the maximization of storage area utilization and the diversification of kitchen equipment. Even with a small, fixed storage capacity, the restaurant operator expects to apply more electrical equipment. Therefore, higher requirements are put forward for the space utilization rate of the electric equipment, such as dishwashers, in the kitchen.

Common dishwashers may use a variety of types of liquid or solid detergents (or chemicals) along with water for cleaning articles. Some chemicals are not properly used or fully utilized, resulting in an inefficient use of chemicals and thereby increasing costs of dishwasher operation and increasing needed storage space for dishwasher chemicals.

It is therefore desirable that a chemical dispenser for a dishwasher be compatible with as many chemicals as possible, so that one dispenser can meet a variety of needs. For different businesses, when using different chemical solutions, the present universal dispenser increases the utilization rate of equipment, but also makes after-sales maintenance easier.

The cost of commercial chemicals is high, but they cannot currently be well monitored in the actual use process, which results in that some chemicals are not properly used and fully utilized. The use process of chemicals should be monitored in real time to understand the use status and utilization rate of each chemical.

Dishwasher detergents are mainly composed of sodium hydroxide, sodium carbonate and various indicating activators of drier. The main task of the dispenser is to accurately distribute the amount of detergent required for cleaning to the dishwasher when it is cleaning. When the dishwasher finishes cleaning and enters the drying process, the dispenser can accurately distribute the required surfactant to the dishwasher. Thus, the dispenser distributes chemicals to the dishwasher on time and on demand, and receives various signals in the dishwasher and give feedback.

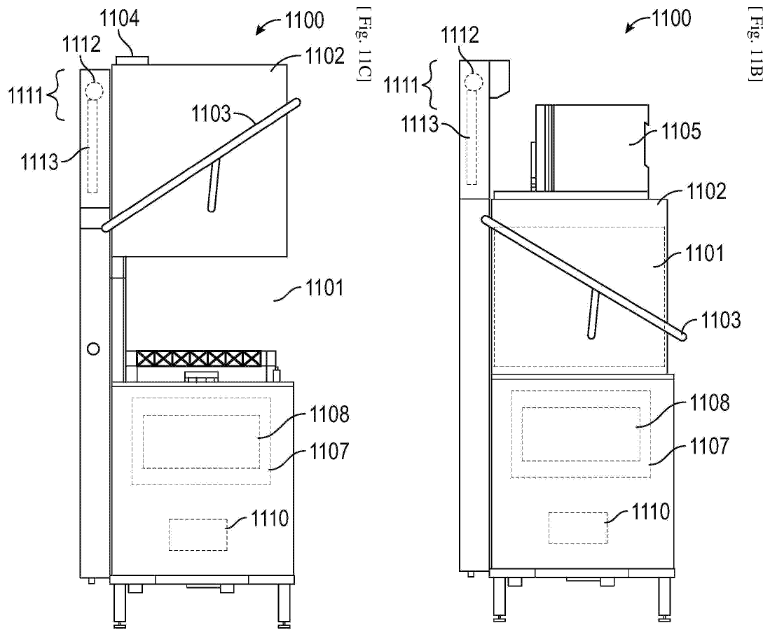

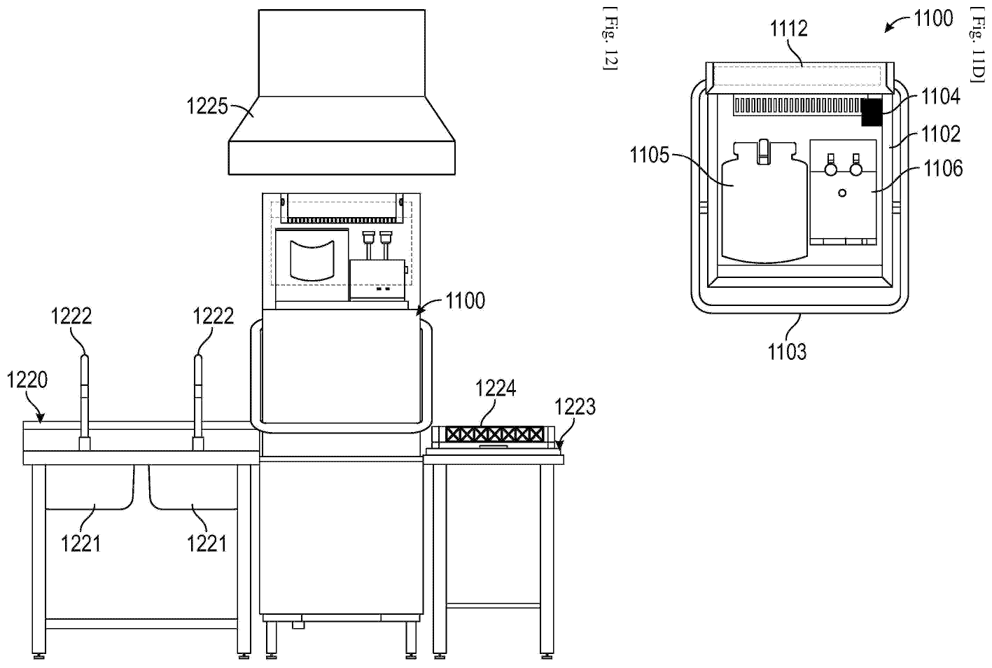

The present subject matter provides a universal dispenser, or chemical distribution device that performs automatic chemical (detergent, rinse aid, etc.) delivery and provides automatic feedback for remaining chemical levels. The chemical distribution device (also referred to herein as a dispenser or dispensing device) is compatible with a plurality of different washing machines and dishwashers, including but not limited to the dishwasher shown in FIGS. 11A-13. The chemical distribution device is compatible with a variety of different brands and types of chemicals including liquids and solids, and is configured to provide for safe use and easy maintenance. The chemical distribution device is configured to monitor remaining chemicals in real time, and meets all waterproof requirements for commercial dishwasher operation.

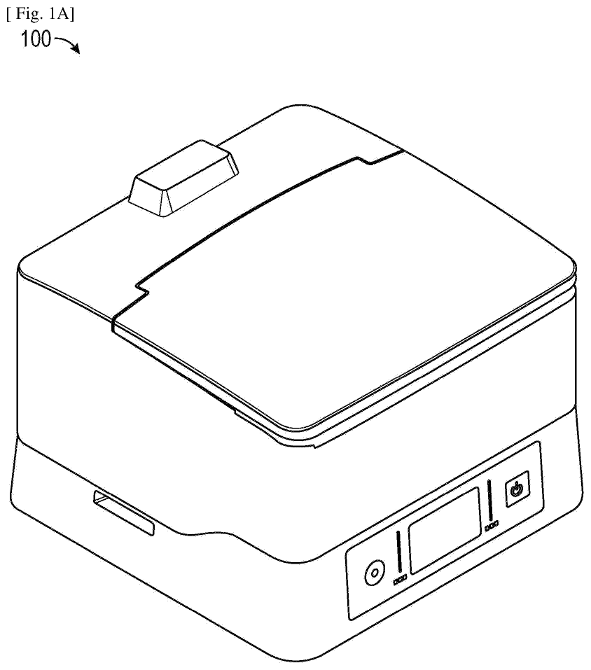

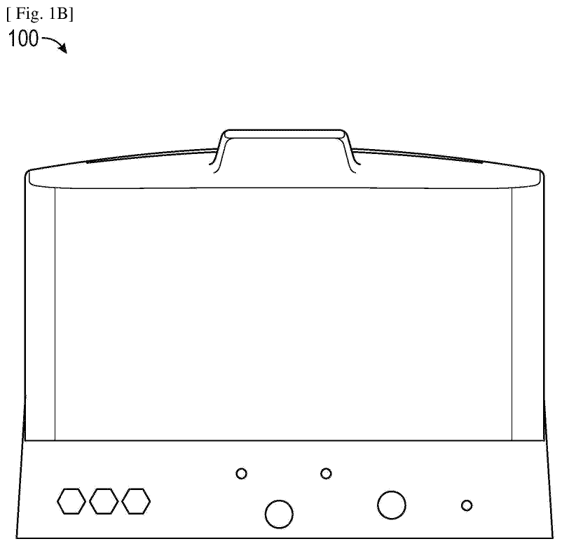

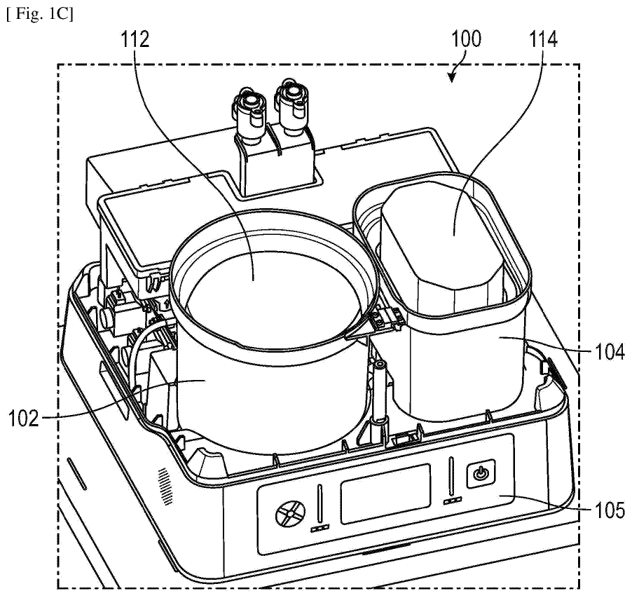

FIG. 1A illustrates a perspective view of a chemical distribution device 100 for a dishwasher, according to various embodiments of the present subject matter. FIG. 1B illustrates a back view of the chemical distribution device 100 for a dishwasher, according to various embodiments of the present subject matter. The present subject matter provides a chemical dispensing device 100 in which the required chemicals can be diluted into the equipment as required. The present chemical dispensing device 100 is compatible with a variety of solid and liquid chemicals, contains features to ensure safe use, and provides for real time monitoring of current chemical residues in the dispenser. In various examples, the present chemical dispensing device 100 meets the chemical dispensing and quick interface requirements of a number of different dishwashers for compatibility. The chemical dispensing device 100 meets the waterproof capacity of IPX4 standards, in various embodiments.

FIG. 1C illustrates a chemical distribution or dispensing device for a dishwasher, including a round barrel solid detergent and a solid rinse aid, according to various embodiments of the present subject matter. The dispensing device 100 is shown with a top portion of the housing removed, and includes a first portion 102 configured to hold and dispense a solid detergent and a liquid detergent, and a second portion 104 configured to hold and dispense a solid rinse aid and a liquid rinse aid. In the depicted embodiment, the first portion 102 contains a round barrel solid detergent 112 and the second portion 104 contains a solid rinse aid 114. In some examples, the round barrel solid detergent 112 includes a solid round carton with a liquid detergent inside said carton. In various examples, the dispensing device 100 further includes a display 105 to provide indications regarding remaining detergent and rinse aid to a user of the device. In various embodiments, a method of forming the chemical distribution or dispensing device is provided as described herein.

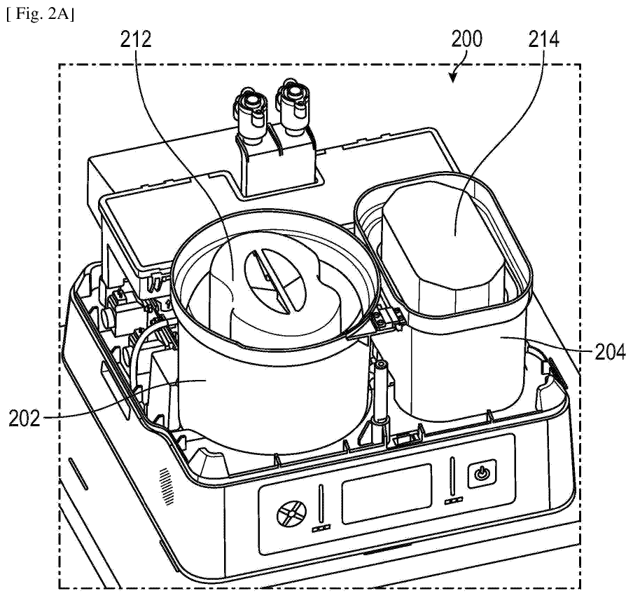

FIG. 2A illustrates a chemical distribution or dispensing device for a dishwasher, including a peanut barrel solid detergent and a solid rinse aid, according to various embodiments of the present subject matter. The dispensing device 200 is shown with a top portion of the housing removed, and includes a first portion 202 configured to hold and dispense a solid detergent and a liquid detergent, and a second portion 204 configured to hold and dispense a solid rinse aid and a liquid rinse aid. In the depicted embodiment, the first portion 202 contains a peanut barrel solid detergent 212 and the second portion 204 contains a solid rinse aid 214. In some examples, the peanut barrel solid detergent 212 includes a solid peanut-shaped carton with a liquid detergent inside said carton.

FIG. 2B illustrates a tray 222 for supporting the peanut barrel solid detergent 212 of FIG. 2A, according to various embodiments of the present subject matter. When using a peanut barrel solid detergent 212, the tray 222 may be added to the first portion 202 so that the peanut barrel solid detergent 212 can stand stably at its installation position, in various examples.

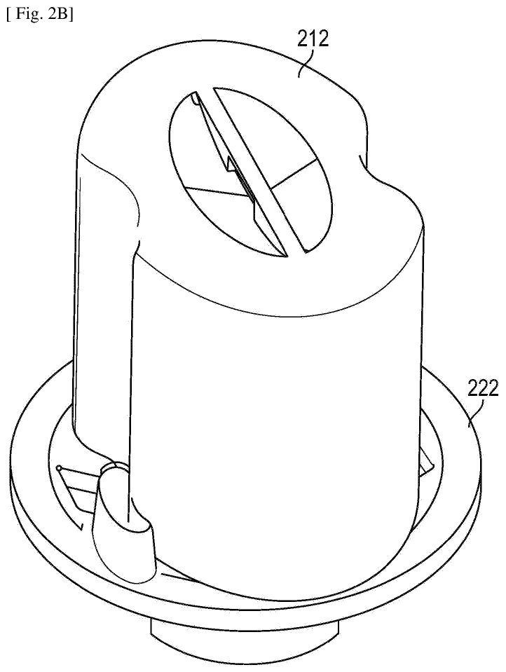

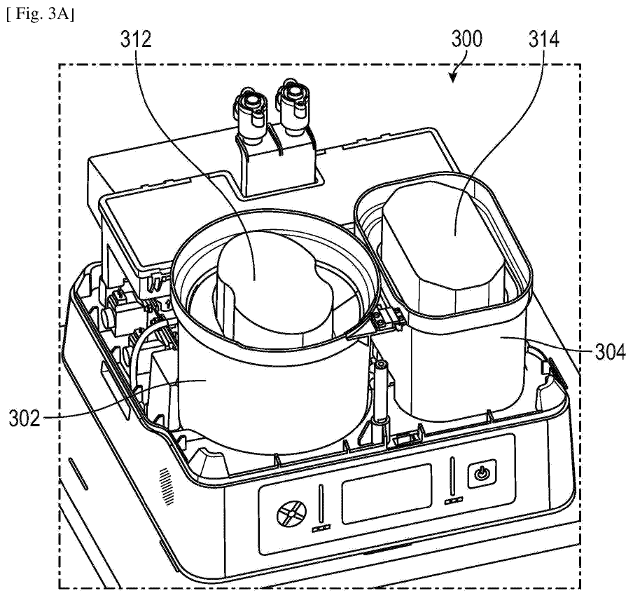

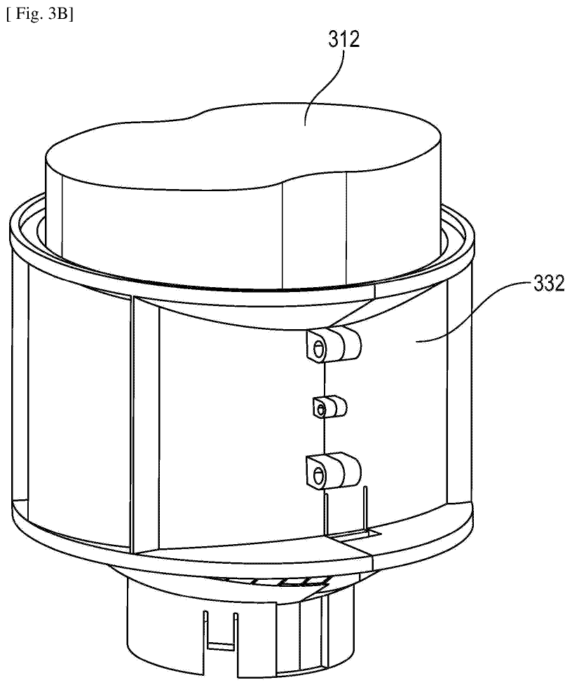

FIG. 3A illustrates a chemical distribution or dispensing device for a dishwasher, including a pressed-solid detergent and a solid rinse aid, according to various embodiments of the present subject matter. The dispensing device 300 is shown with a top portion of the housing removed, and includes a first portion 302 configured to hold and dispense a solid detergent and a liquid detergent, and a second portion 304 configured to hold and dispense a solid rinse aid and a liquid rinse aid. In the depicted embodiment, the first portion 302 contains a pressed-solid detergent 312 and the second portion 304 contains a solid rinse aid 314.

FIG. 3B illustrates a housing 332 for supporting the pressed-solid detergent 312 of FIG. 3A, according to various embodiments of the present subject matter. When using a pressed-solid detergent 312, the housing 332 may be added to the first portion 302 so that the pressed-solid detergent 312 can stand stably at its installation position, in various examples. In some examples, the pressed-solid detergent 312 includes a peanut shape, as depicted in FIG. 3B.

FIG. 4 illustrates a chemical distribution or dispensing device for a dishwasher, including a round barrel solid detergent and a liquid rinse aid, according to various embodiments of the present subject matter. FIGS. 4-5 are a back perspective view of the dispensing device 400 shown with a top portion of the housing removed, and the dispensing device includes a first portion 402 configured to hold and dispense a solid detergent and a liquid detergent, and a second portion 404 configured to hold and dispense a solid rinse aid and a liquid rinse aid. In the depicted embodiment, the first portion 402 contains a solid detergent 412 and the second portion 404 contains a liquid rinse aid 414. To accommodate the liquid rinse aid 414, the pump inlet is changed from the inside to the outside of the second portion 404 and the flushing system 424 for the solid rinse aid is removed, in various examples. In various embodiments, a one way pressure relief valve 434 is removed and a solid rinse aid solenoid valve 444 is removed to accommodate the liquid rinse aid 414. In various examples, the liquid rinse aid 414 may be drawn from the outside of the dispensing device 400 using a liquid rinse aid port 454. The present dispensing device may be used with a plurality of different solid, pressed-solid and liquid detergent, rinse aid and descaling aid chemicals, in various embodiments. Examples include, but are not limited to detergents such as solid power plus, solid ultra clean, pressed-solid, and express; rinse aids such as elite and solid ultra-dry; and descaling aids such as strip-a-way.

FIG. 5 illustrates a chemical distribution or dispensing device for a dishwasher, including a liquid detergent and a solid rinse aid, according to various embodiments of the present subject matter. The dispensing device 400 is shown with a top portion of the housing removed, and includes a first compartment 502 configured to hold and dispense a solid detergent and a liquid detergent, and a second compartment 504 configured to hold and dispense a solid rinse aid and a liquid rinse aid. In the depicted embodiment, the first compartment 502 contains a liquid detergent 512 and the second compartment 504 contains a solid rinse aid 514. To accommodate the liquid detergent 512, a liquid detergent pump 552 is added and the flushing system 522 for the solid detergent is removed, in various examples. In various embodiments, a solid detergent solenoid valve 542 is removed, and a one way pressure relief valve 532 is removed, to accommodate the liquid detergent 512. In various embodiments, to accommodate the dispensing of a liquid detergent and a liquid rinse aid, the embodiments of FIG. 4 (for the liquid rinse aid portion) and FIG. 5 (for the liquid detergent portion) can be combined.

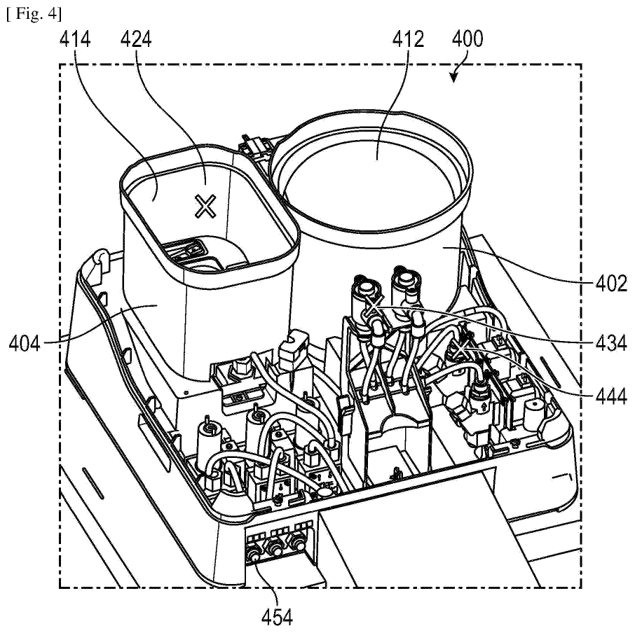

FIG. 6 illustrates an internal portion of a chemical distribution or dispensing device for a dishwasher, including a one-way pressure relief valve and a solenoid valve, according to various embodiments of the present subject matter. Various portions of the present subject matter provide for easy maintenance and safe use of the chemical distribution or dispensing device 600. The use of a one-way pressure relief valve 610 can prevent siphonage and ensure that chemicals will not flow back into the tap water circuit, in various examples. In one example, after the solenoid valve 620 is opened, water enters the one-way relief valve 610 and then the flushing system. When the solenoid valve 620 is closed, the water in the inlet section of the pressure relief valve 610 will remain unchanged, and the outlet section will decline with the gravity, and air will enter the top opening of the valve to isolate the tap water from the water that may contain chemicals. Even if the solenoid valve cannot be closed due to failure, siphoning occurs, and the water containing chemicals is separated by the air column, preventing pollution of the water source.

In various examples, the present subject matter provides for the use of a door magnetic switch that can prevent accidental cover opening and spray of the spraying system. When the dispenser cover is opened, the magnetic door switch will cut off the solenoid valve so that no flushing occurs, in various examples.

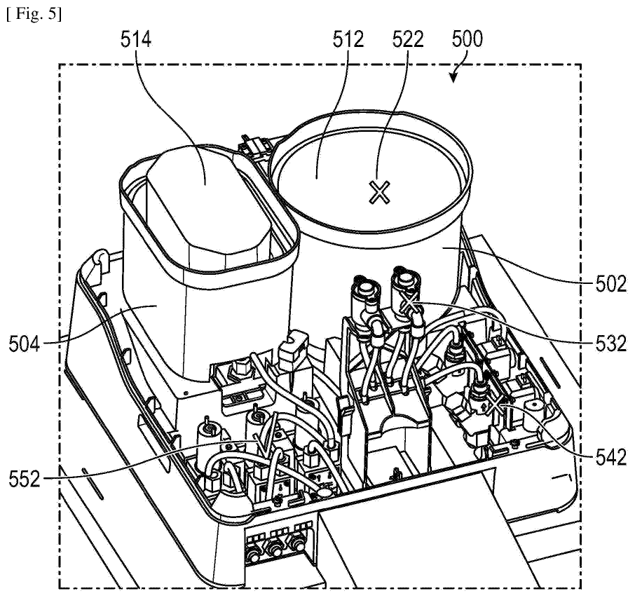

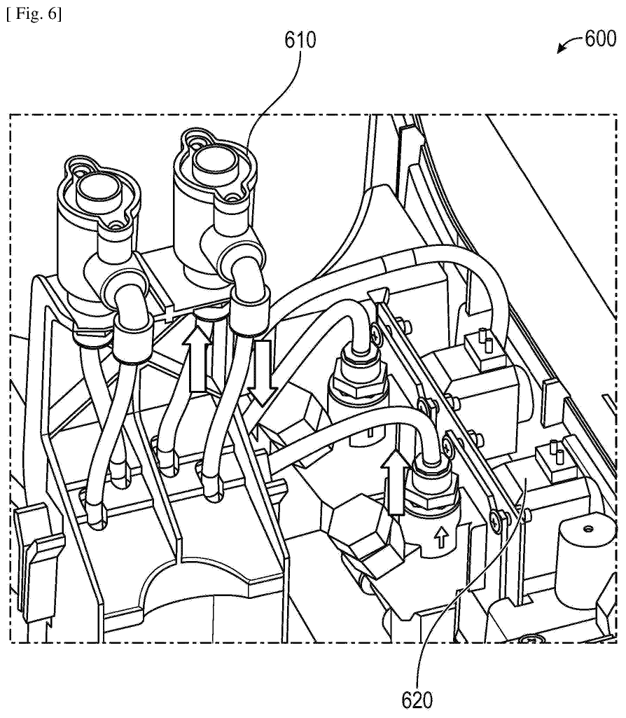

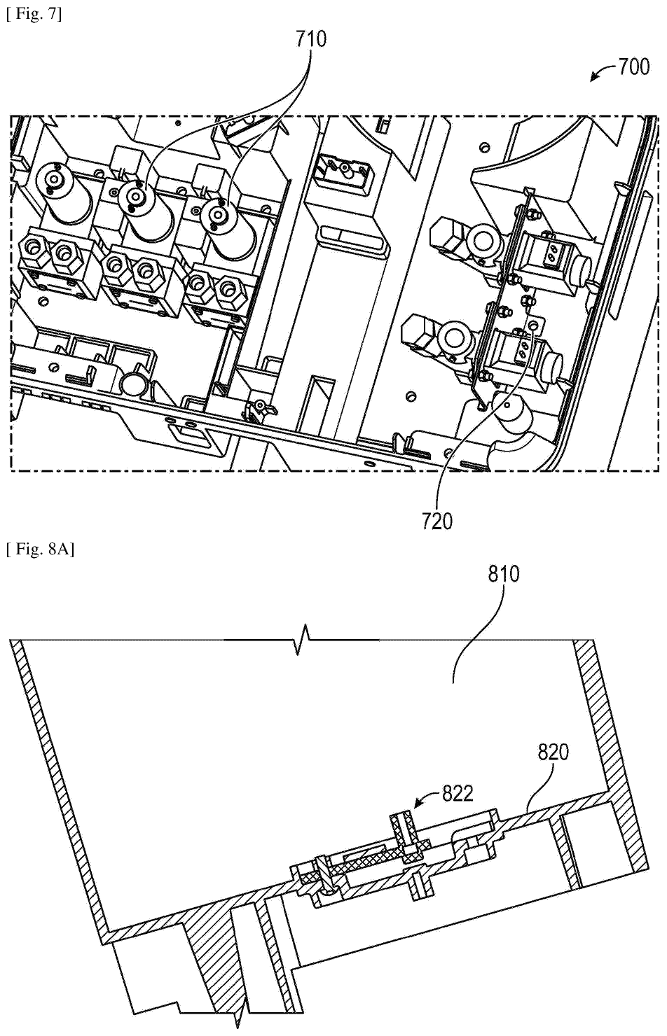

FIG. 7 illustrates an internal portion of a chemical distribution or dispensing device for a dishwasher, including a pump module and a solenoid valve, according to various embodiments of the present subject matter. In various examples, a descaling pump, a detergent pump and a rinse aid pump are all fixed on the base of the dispensing device 700 through a sheet metal bracket. When the pump fails, a user may remove the two pump module fix screws 710 on the sheet metal to remove the three pumps together, which is very convenient for pump maintenance. The detergent solenoid valve and rinse aid solenoid valve are also fixed in the same way using a solenoid valve module fixing screw 720. Removing the fixing screw 720 on the sheet metal allows a user to remove the two solenoid valves together for convenient maintenance, in various examples. In various examples, the chemical distribution or dispensing device is connected or attached to a water supply to assist in chemical distribution and flushing of the respective compartments.

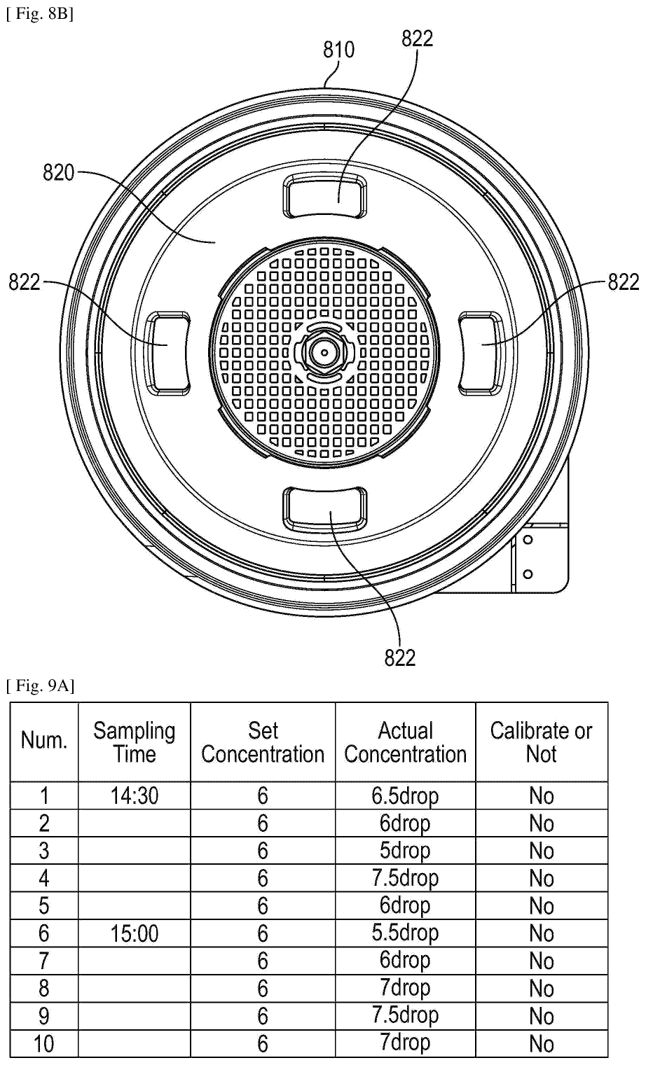

FIG. 8A illustrates an internal portion of a chemical distribution or dispensing device for a dishwasher, including a weight sensor, according to various embodiments of the present subject matter. In various examples, the dispensing device provides for monitoring of remaining chemicals (detergent or rinse aid) in real time. In various embodiments, one or more weight sensors 822 are arranged at or near a bottom surface 820 of a container 810 of chemicals to convert the change of weight signal into the change of current signal, so as to detect the change of chemical weight in real time.

FIG. 8B illustrates an internal portion of a chemical distribution or dispensing device for a dishwasher, including a plurality of weight sensors, according to various embodiments of the present subject matter. In various embodiments, four weight sensors 822 are uniformly arranged at the bottom of the chemical to detect a change of weight of the chemical in real time. Other numbers of sensors may be used without departing from the scope of the present subject matter.

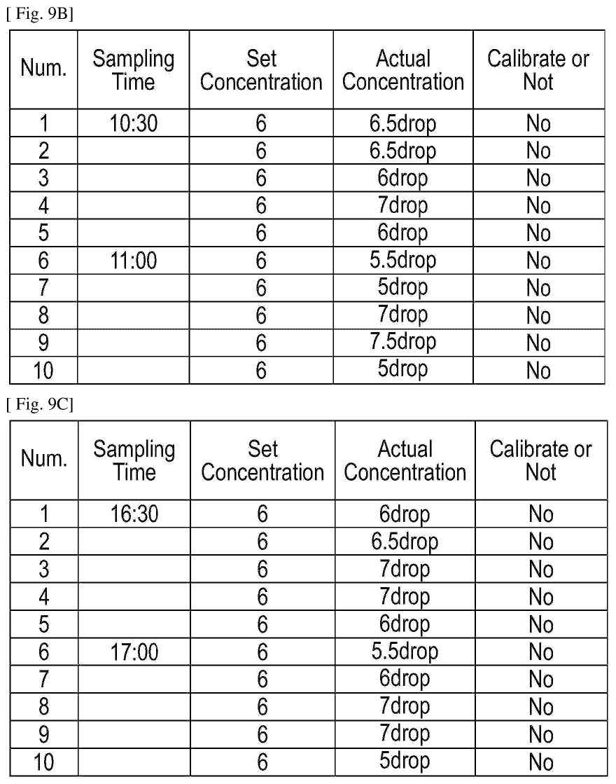

FIG. 9A illustrates a table including test results for sensing detergent in a round barrel in a chemical distribution device for a dishwasher, according to various embodiments of the present subject matter. For a compatible detergent in round barrel, the concentration of the detergent dispensed is tested as shown in the table. FIG. 9B illustrates a table including test results for sensing detergent in a peanut barrel in a chemical distribution device for a dishwasher, according to various embodiments of the present subject matter. For a compatible detergent in peanut barrel, the concentration of the detergent dispensed is tested as shown in the table. FIG. 9C illustrates a table including test results for sensing pressed-solid detergent in a chemical distribution device for a dishwasher, according to various embodiments of the present subject matter. For a compatible detergent in pressed-solid, the concentration of the detergent dispensed is tested as shown in the table. As shown from the test results in each of the tables, a desired concentration accuracy of ±2 drops is met using the dispensing device of the present subject matter.

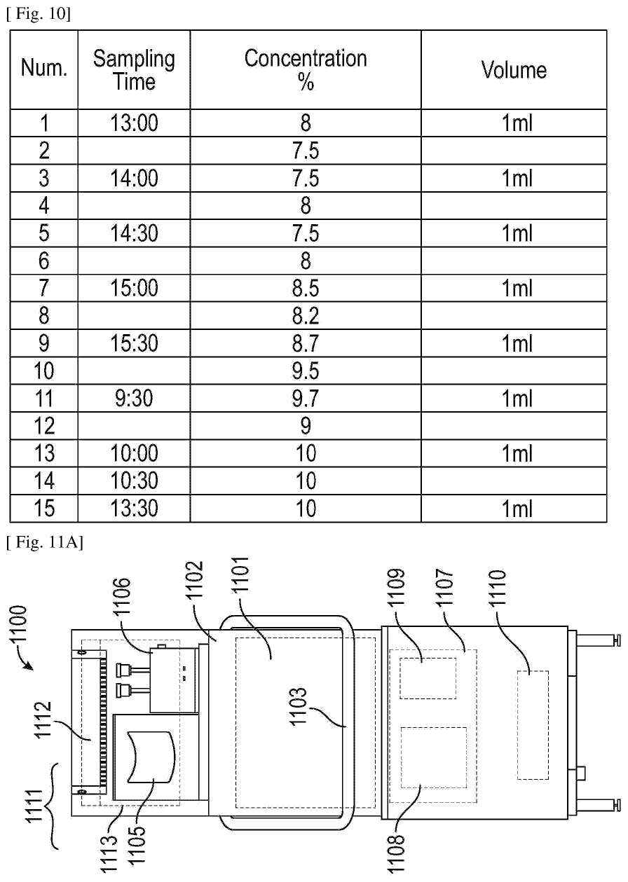

FIG. 10 illustrates a table including test results for sensing solid rinse aids in a chemical distribution device for a dishwasher, according to various embodiments of the present subject matter. For compatible solid rinse aids, the single distribution accuracy is tested as shown in the table. As shown in the test results in the table, a desired concentration accuracy of 6%-12% is met. Thus, the precision of single dispensing of detergent and rinse aids is high.

In addition, the present dispensing device provides for safety and easy maintenance. The one-way pressure relief valve of the dispenser has shown that during normal use, there is an air column of more than 20 cm at the upper end of the outlet pipe of the one-way valve, which meets the requirements of preventing chemicals from entering the water supply in an unintended manner. After the cover is opened, the magnetic switch is disconnected and the dispenser stops working, preventing engagement of the flushing system. The installation and maintenance of various pumps and solenoid valves are convenient, providing additional benefits to the user. As shown above, the present dispensing device provides for real time monitoring of residual chemicals. In various embodiments, the dispenser displays the current remaining amount of chemicals, and when the chemicals are consumed, the light will turn on for the display, with an accompanying alarm tone in an embodiment. In some embodiments, the light turns on with or without the alarm tone. In some embodiments, the alarm tone may be independent of the light on the display. In various examples, if the amount of the remaining chemical is detected or weighs below a programmable threshold, the lights and/or alarm may be activated. In various embodiments, the remaining detergent and rinse aid are monitored separately.

As used in the present disclosure, a “dishwasher” (also known as dish washing machine, warewasher, or warewashing machine) can include any type of washing machine that can use detergent for cleaning and/or sanitizing purposes in domestic or commercial settings. Objects to be washed in a dishwasher can include dinnerware, flatware, pots and pans, cutlery, flatware, glasses, kitchenware, serving pans, trays, and the like. Such objects can be placed in a dishwasher rack in the dishwasher. The “dishwasher rack” (also known as warewashing rack) can include any rack that is used in a dishwasher for holding any objects to be washed. Unless noted otherwise, a “rack” in the present disclosure refers to a dishwasher rack. The rack can be a built-in part of the dishwasher or a removable accessory suitable for use in the dishwasher. The rack can be a peg rack or an open rack and can have any size and shape suitable for the dishwasher. Each dishwasher can include one or more built-in racks and/or can host one or more removable racks.

As used in the present disclosure, a “cleaning cycle” of the dishwasher can include various operational periods, such as one or more of a descaling period, a washing period, a rinsing period, and a drying period, depending on the availability of respective operational modes in the dishwasher and settings entered by a user of the dishwasher. “Cleaning” can include cleaning only, sanitizing only, cleaning and sanitizing, descaling and cleaning, or descaling, cleaning, and sanitizing. A “descaling period” includes a period or operational mode that is intended for a descaling liquid formed by water and a descaler to be applied to the objects being cleaned. A “washing period” includes a period or operational mode that is intended for a washing liquid formed by water and a detergent to be applied to the objects being washed. A “rinsing period” includes a period or operational mode that is intended for water, or a rinsing liquid formed by water and a rinse aid and/or a sanitizer, to be applied to the objects being cleaned. Some dishwashers (e.g., commercial dishwashers) may include a rinsing period that is primarily for sanitizing through heat and/or chemical means. The descaler, detergent, rinsing aid, and sanitizer can each be a chemical agent or a mixture of chemical agents in liquid or solid form. A “drying period” includes a period or operational mode that is intended for the cleaned objects to be dried by air flow and/or heat, without additional water and/or chemical agent applied.

A trend of franchising food service businesses has raised a need for miniaturizing stores while maximizing store area utilization and the diversifying kitchen equipment. A store (e.g., restaurant) may face the challenge of increasing usage of electrically powered equipment without increasing the capacity of the existing electrical power system. The electrical power available for operating a dishwasher, an electrical appliance commonly used in a restaurant or other food service establishment, may be limited, while the cleaning effectiveness of the dishwasher is not to be compromised.

The chemical distribution device 100 (also referred to herein as a dispenser or dispensing device) of the present subject matter is compatible with a plurality of different washing machines and dishwashers, including but not limited to the dishwasher 1100 shown in FIGS. 11A-13. In one example, the chemical distribution device 100 is used as dispenser 1105 discussed below.

FIGS. 11A, 11B, 11C, and 11D are illustrations of an embodiment of a dishwasher 1100. As shown in FIGS. 11A-11D and discussed as an example for illustrative but not restrictive purposes, dishwasher 1100 is a hood-type dishwasher that includes a hood 1102 to cover a wash chamber (also known as a main wash chamber) 1101 during each cleaning cycle. A hood lifting handle 1103 can be elevated by a user to open hood 1102 for loading objects to be washed into wash chamber 1101 before a cleaning cycle, lowered by the user to close hood 1102 to cover the wash chamber 1101 before starting the cleaning cycle, and elevated by the user to open hood 1102 for unloading the cleaned objects after the cleaning cycle is completed. A hood lock 1104 installed on hood 1102 is automatically locked when a cleaning cycle starts to prevent hood 1102 from being accidentally opened during the clean cycle. FIG. 11A shows a front view of dishwasher 1100 when hood 1102 is closed. FIG. 11B shows a side view of dishwasher 1100 when hood 1102 is closed. FIG. 11C shows a side view of dishwasher 1100 when hood 1102 is open. FIG. 11D shows a top view of dishwasher 1100.

Dishwasher 1100 includes a dispenser 1105 that contains various chemical agents for dispensing during different periods of the cleaning cycle. Each chemical agent may be in liquid or solid form, and dispenser 1105 is configured to accommodate liquid and/or solid forms for each chemical agent, depending on the form(s) of the chemical agent that is available and intended to use. Each chemical agent in dispenser 1105 is refillable. In one example, dishwasher 1100 can perform cleaning cycles including a descaling period, a washing period, and a rinsing period, and dispenser 1105 is an integrated dispenser that can contain a descaler, a detergent, and a rinse aid and can dispense the descaler for use during the descaling period, the detergent for use during the washing period, and the rinse aid for use during the rinsing period.

Dishwasher 1100 includes a user interface 1106 that visually and/or audially indicates its operational status and allows the user to control its operations. User interface 1106 can include a display screen, such as a touchscreen that can display the operation status of dishwasher 1100 and receive commands and other information from the user. User interface 1106 can include a power switch for the user to turn the electrical power for dishwasher 1100 on and off. User interface 1106 allows the user to start a cleaning cycle, optionally after indicating to the user that the cleaning cycle is ready to start (e.g., after hood 1102 is closed). In one example, user interface 1106 allows the user to select which period(s) to include in the cleaning cycle. The user may select only the rinsing period when, for example, dishes are known to be clean but needs disinfection. The user may select the washing and rinsing periods only when a need for descaling dishes is not indicated. In another example, user interface 1106 is configured (e.g., programmed) for following a hygiene procedure and/or complying with a regulation for ensuring food safety.

Dishwasher 1100 provides high space and power efficiency to lower operational cost and/or allowing a food service establishment to operate under limited space and/or electrical power capacity. For example, dishwasher 1100 includes an internal wastewater recycling system 1107 and an internal steam reduction system 1111 to recover thermal energy resulting from the operations during each cleaning cycle for heating clean water to be used in the operations. Wastewater recycling system 1107 includes a wash tank (also known as main wash tank) 1108 recycling a hot washing liquid to be sprayed into, and returning from, wash chamber 1101 during the washing period and a wastewater tank 1109 (also known as overflow tank) to receive excessive hot washing liquid from wash tank 1108 as wastewater. A heat exchange module is placed in wastewater tank 1109 to heat clean water while cooling the wastewater before it is discharged to a drain (e.g., a drain connected to the sewage of the building). The heated clean water is to be added to wash tank 1108 and a booster tank (also known as rinse tank) 1110 as needed. In the illustrated example, booster tank 1110 receives the clean water and the descaler to form a descaling liquid to be sprayed into wash chamber 1101 during the descaling period and receives the clean water and the rinse aid to form a rinsing liquid to be sprayed into wash chamber 1101 during the rinsing period. Steam reduction system 1111 includes a fan 1112 to draw steam from wash chamber 1101 and a condenser 1113 positioned in the steam path to condense the steam while heating the clean water (in addition to the heat recovery from the wastewater). Fan 1112 blows the remaining steam out of dishwasher 1100.

Dishwash 1100 can be sized to allow for easy operation and maintenance by a user having a height of 150 cm or taller. Force required to open hood 1102 by elevating hood lifting handle 1103 can be around 3.5 kg or lighter. In one example, wash tank 1108 has a capacity of about 24 L, wastewater tank 1108 has a capacity of about 12 L, and booster tank 1110 has a capacity of about 10 L.

FIG. 12 is an illustration of an embodiment of dishwasher 1100 with several accessories. As shown in FIG. 12 as an example for illustrative but not restrictive purposes, the accessories can include a dirty dish stand 1220, a clean dish stand 1223, a dishwasher rack 1224, and a vent hood 1225. Dirty dish stand 1220 includes one or more sinks 1221 and one or more faucets 1222. When necessary or convenient, dishes and/or other objects to be cleaned can be placed in sink(s) 1221 and pre-washed using water from faucet(s) 1222 before being loaded into wash chamber 1101 (with hood 1102 open). Rack 1224 can be placed in wash chamber 1101 when empty, and the dishes and/or other objects can be placed into rack 1224 for each cleaning cycle. After the cleaning cycle is completed, rack 1224 loaded with the cleaned dishes and/or other objects can be removed from wash chamber 1101 (with hood 1102 open) and placed on clean dish stand 1223 before use and/or further distribution. Vent hood 1225 can vent the steam blown out of dishwasher 1100 by fan 1112 to outside of the building in which dishwasher 1100 is placed.

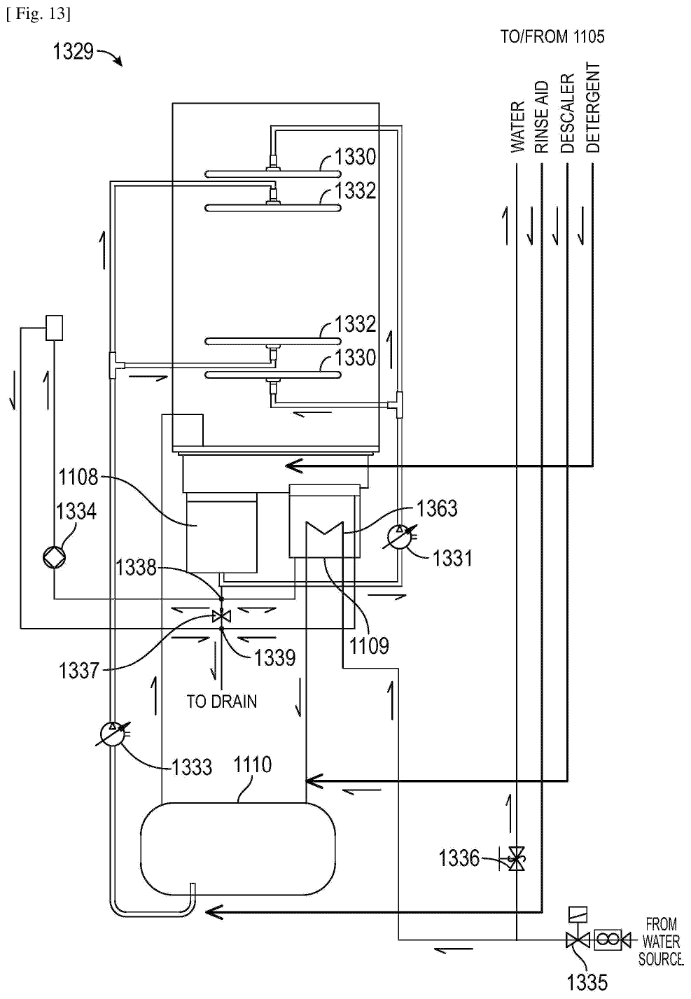

FIG. 13 is an illustration of an embodiment of a hydraulic system 1329 of dishwasher 1100. As shown in FIG. 12 as an example for illustrative but not restrictive purposes, hydraulic system 1329 can support liquid movement functions during the descaling period, the washing period, and the rinsing period.

Hydraulic system 1329 includes a main water valve 1335 (e.g., an electromagnetically controlled valve) that can be opened to receive clean water from a water source (e.g., a water main of the building). The clean water can be heated in wastewater tank 1109 and then routed to wash tank 1108 and booster tank 1110. The clean water can also be routed to dispenser 1105, when needed (e.g., for dissolving one or more chemical agents in solid form(s) ), through a dispenser valve 1336.

During the descaling period, the descaler is dispensed from dispenser 1105 into booster tank 1110 to form the descaling liquid with the heated clean water in booster tank 1110. The descaling liquid is pumped by a rinse pump 1333 to rinse arms 1330. Rinse arms 1330 are positioned above and under wash chamber 1101 and rotated to spray the scaling liquid into wash chamber 1101 from above and under. The descaling liquid flows into wash tank 1108 after passing through wash chamber 1101.

During the washing period, the detergent is dispensed from dispenser 1105 into wash tank 1108 to form the washing liquid with the heated clean water in wash tank 1108. The washing liquid is pumped by a wash pump 1331 to wash arms 1332. Wash arms 1332 are positioned above and under wash chamber 1101 and rotated to spray the washing liquid into wash chamber 1101 from above and under. The washing liquid returns to wash tank 1108 after passing through wash chamber 1101.

During the rinsing period, the rinse aid is dispensed from dispenser 1105 into booster tank 1110 to form the rinsing liquid with the heated clean water in booster tank 1110. The rinsing liquid is pumped by rinse pump 1333 to rinse arms 1330. Rinse arms 1330 are rotated to spray the rinsing liquid into wash chamber 1101 from above and under. The rinsing liquid flows into wash tank 1108 after passing through wash chamber 1101.

Thus, wash tank 1108 collects all the liquid sprayed into wash chamber 1101. When the level of the liquid in wash tank 1108 exceeds a set threshold, the excessive liquid flows into wastewater tank 1109 as the wastewater. In an example, as illustrated in FIG. 13, hydraulic system 1329 includes a wastewater recycling system that includes a drain valve 1337 and two watertight or waterproof seals 1338 and 1339 to separate the wastewater from drain water (which is the wastewater ready to be discharged from dishwasher 1100 to the drain. A drain pump 1334 pumps the drain water out of the wastewater recycling system to the drain. When drain pump 1334 is turned off and drain valve 1337 is closed, the wastewater flows out of the wash tank 1108 into wastewater tank 1109 and then flows out of wastewater tank 1109 and turns into the drain at seal 1338. When drain pump 1334 is turned on and drain valve 1337 is closed, the wastewater flows out of wastewater tank 1109 (as being pumped) through the path including drain pump 1334 and turns into the drain at seal 1338. When drain valve 1337 is open, the wastewater flows from wash tank to the drain directly (without flowing through wastewater tank 1109 or drain pump 1334. A heat exchange coil 1363 is placed in wastewater tank 1109. The clean water flows through heat exchange coil 1363 to be heated by the wastewater before being routed into wash tank 1109 or booster tank 1110, while the wastewater is cooled by the clean water before being discharged to the drain.

Some non-limiting examples (Examples 1-20) of the present subject matter are provided as follows:

In Example 1, a dispensing device for a washing machine may include a first portion configured to hold and dispense a solid detergent and configured to dispense a liquid detergent, and a second portion configured to hold and dispense a solid rinse aid and configured to dispense a liquid rinse aid, wherein at least one of the first portion or the second portion includes at least one weight sensor on a bottom interior surface, the at least one weight sensor configured to monitor an amount of remaining contents of the at least one of the first portion or the second portion.

In Example 2, the subject matter of Example 1 may optionally be configured where the at least one weight sensor configured to detect a change in weight of contents of the at least one of the first portion or the second portion.

In Example 3, the subject matter of any one or any combination of Examples 1 or 2 may optionally be configured where the at least one weight sensor includes four uniformly arranged weight sensors.

In Example 4, the subject matter of any one or any combination of Examples 1-3 may optionally be configured to further include a display including an indication of the amount of remaining contents of the first portion or the second portion.

In Example 5, the subject matter of Example 4 may optionally be configured where, when the amount of remaining contents is less than a programmable threshold, a light is illuminated on the display.

In Example 6, the subject matter of any one or any combination of Examples 4-5 may optionally be configured where, when the amount of remaining contents is less than a programmable threshold, an alarm tone is activated by the device.

In Example 7, the subject matter of any one or any combination of Examples 1-6 may optionally be configured where the first portion is configured to receive a round barrel of detergent.

In Example 8, the subject matter of any one or any combination of Examples 1-7 may optionally be configured where the first portion is configured to receive a peanut-shaped barrel of detergent.

In Example 9, the subject matter of any one or any combination of Examples 1-8 may further include a tray in the first portion to support the solid detergent.

In Example 10, the subject matter of any one or any combination of Examples 1-9 may optionally be configured where the solid detergent includes a pressed-solid detergent.

In Example 11, the subject matter of any one or any combination of Examples 1-10 may further include a one-way pressure relief valve configured to prevent contents of the first portion and the second portion from flowing into an attached water supply.

In Example 12, the subject matter of any one or any combination of Examples 1-11 may further include a door magnetic switch configured to prevent flushing of the first portion and the second portion when a door of the dispensing device is open.

In Example 13, a method for making a dispensing device for a washing machine may include providing a first compartment configured to hold and dispense a solid detergent and configured to dispense a liquid detergent, providing a second compartment configured to hold and dispense a solid rinse aid and configured to dispense a liquid rinse aid, and providing at least one weight sensor on a bottom interior surface of at least one of the first compartment or the second compartment, the at least one weight sensor configured to monitor an amount of remaining contents of the at least one of the first compartment or the second compartment.

In Example 14, the subject matter of Example 13 may further include providing a display for the dispensing device including an indication of the amount of remaining contents of the first compartment or the second compartment.

In Example 15, the subject matter of Example 14 may optionally be configured where, when the amount of remaining contents is less than a programmable threshold, a light is illuminated on the display.

In Example 16, the subject matter of any one or any combination of Examples 14-15 may optionally be configured where, when the amount of remaining contents is less than a programmable threshold, an alarm tone is activated by the device.

In Example 17, the subject matter of any one or any combination of Examples 13-16 may further include providing a tray in the first compartment to support the solid detergent.

In Example 18, the subject matter of any one or any combination of Examples 13-17 may optionally be configured where the solid detergent includes a pressed-solid detergent.

In Example 19, the subject matter of any one or any combination of Examples 13-18 may further include providing a one-way pressure relief valve configured to prevent contents of the first compartment and the second compartment from flowing into an attached water supply.

In Example 20, the subject matter of any one or any combination of Examples 13-19 may further include providing a door magnetic switch configured to prevent flushing of the first compartment and the second compartment when a door of the dispensing device is open.

This application is intended to cover adaptations or variations of the present subject matter. It is to be understood that the above description is intended to be illustrative, and not restrictive. The scope of the present invention should be determined with reference to the appended claims, along with the full scope of legal equivalents to which such claims are entitled.

1. A dispensing device for a washing machine, the device comprising:
a first portion configured to hold and dispense a solid detergent and configured to dispense a liquid detergent; and
a second portion configured to hold and dispense a solid rinse aid and configured to dispense a liquid rinse aid;
wherein at least one of the first portion or the second portion includes at least one weight sensor on a bottom interior surface, the at least one weight sensor configured to monitor an amount of remaining contents of the at least one of the first portion or the second portion.

2. The device of claim 1, wherein the at least one weight sensor configured to detect a change in weight of contents of the at least one of the first portion or the second portion.

3. The device of claim 1, wherein the at least one weight sensor includes four uniformly arranged weight sensors.

4. The device of claim 1, further comprising a display including an indication of the amount of remaining contents of the first portion or the second portion.

5. The device of claim 4, wherein, when the amount of remaining contents is less than a programmable threshold, a light is illuminated on the display.

6. The device of claim 4, wherein, when the amount of remaining contents is less than a programmable threshold, an alarm tone is activated by the device.

7. The device of claim 1, wherein the first portion is configured to receive a round barrel of detergent.

8. The device of claim 1, wherein the first portion is configured to receive a peanut-shaped barrel of detergent.

9. The device of claim 1, further comprising a tray in the first portion to support the solid detergent.

10. The device of claim 1, wherein the solid detergent includes a pressed-solid detergent.

11. The device of claim 1, further comprising a one-way pressure relief valve configured to prevent contents of the first portion and the second portion from flowing into an attached water supply.

12. The device of claim 1, further comprising a door magnetic switch configured to prevent flushing of the first portion and the second portion when a door of the dispensing device is open.

13. A method for making a dispensing device for a washing machine, the method comprising:
providing a first compartment configured to hold and dispense a solid detergent and configured to dispense a liquid detergent;
providing a second compartment configured to hold and dispense a solid rinse aid and configured to dispense a liquid rinse aid; and
providing at least one weight sensor on a bottom interior surface of at least one of the first compartment or the second compartment, the at least one weight sensor configured to monitor an amount of remaining contents of the at least one of the first compartment or the second compartment.

14. The method of claim 13, further comprising:
providing a display for the dispensing device including an indication of the amount of remaining contents of the first compartment or the second compartment.

15. The method of claim 14, wherein, when the amount of remaining contents is less than a programmable threshold, a light is illuminated on the display.

16. The method of claim 14, wherein, when the amount of remaining contents is less than a programmable threshold, an alarm tone is activated by the device.

17. The method of claim 13, further comprising:
providing a tray in the first compartment to support the solid detergent.

18. The method of claim 13, wherein the solid detergent includes a pressed-solid detergent.

19. The method of claim 13, further comprising:
providing a one-way pressure relief valve configured to prevent contents of the first compartment and the second compartment from flowing into an attached water supply.

20. The method of claim 13, further comprising:
providing a door magnetic switch configured to prevent flushing of the first compartment and the second compartment when a door of the dispensing device is open.
